(19) United States
(12) Patent Application Publication
(10) Pub. No.: US 2026/0127686 A1
(43) Pub. Date: May 7, 2026

(54) DISTRIBUTED ENERGY RESOURCE MARKET SCHEDULER

(71) Applicant: Voltus, Inc., San Francisco, CA (US)

(72) Inventors: Dana Guernsey, Boulder, CO (US); Neil Robert Lakin, Glendale, CA (US); Vivian Ginsberg Brown, Berkeley, CA (US); William Michael Kusters, Brooklyn, NY (US); Noah Patric Megregian, Waltham, MA (US); Elizaveta Polyudova, Montreal (CA)

(21) Appl. No.: 18/939,001

(22) Filed: Nov. 6, 2024

Related U.S. Application Data
(60) Provisional application No. 63/547,499, filed on Nov. 6, 2023.

(51) Int. Cl. G06Q 50/06; G06Q 10/0631; H02J 3/38

(52) U.S. Cl. CPC G06Q 50/06; G06Q 10/0631; H02J 3/381; H02J 2103/30; H02J 2103/35

(57) ABSTRACT

A method for managing a virtual power plant on a user interface includes displaying, in a first portion of the user interface, a calendar grid of cells, the calendar grid including multiple columns each corresponding to available dates and including rows each corresponding to time slots. The method further includes receiving a first user input in a second portion of the user interface to create a power generation offer from a particular distributed energy resource at a particular time slot and a particular date, and in response to receiving the first user input, displaying the power generation offer on the calendar grid within a particular cell corresponding to the particular time slot and the particular date. The method further includes, in response to receiving the first user input, submitting the power generation offer to a distributed energy resource market.

### CROSS-REFERENCE OF RELATED APPLICATION

This application claims the benefit of U.S. Provisional Application No. 63/547,499, filed on Nov. 6, 2023, and which is incorporated herein in its entirety.

### TECHNICAL FIELD

The present disclosure generally relates to energy resource markets, and more particularly to user interfaces for scheduling energy resources.

### BACKGROUND

Virtual power plants (VPPs) are networks of decentralized energy resources (DERs) that are collectively managed by a central control system. Unlike traditional power plants, VPPs don't exist in a single physical location but operate as if they were one interconnected system.

However, VPPs must compete with established traditional power plants in highly competitive energy markets. Current market structures may not provide adequate incentives for VPPs to compete effectively. VPPs also face financial uncertainty due to the variability in electricity markets and the need to rely on various revenue streams. Individual owners/operators of DERs participating in a VPP face financial uncertainty and lack of control over their energy systems.

As such, there is a need for improving the flexibility of VPPs and profitability for participating DERs.

### SUMMARY

Some embodiments of the present disclosure provide a method for managing a virtual power plant on a user interface. The method includes displaying, in a first portion of the user interface, a calendar grid of cells, the calendar grid having a group of columns each corresponding to a group of available dates and a group of rows each corresponding to a group of time slots. The method further includes receiving a first user input in a second portion of the user interface to create a power generation offer from a particular distributed energy resource at a particular time slot and a particular date. The method further includes, in response to receiving the first user input, displaying the power generation offer on the calendar grid within a particular cell corresponding to the particular time slot and the particular date. The method further includes, in response to receiving the first user input, submitting the power generation offer to a distributed energy resource market.

Some embodiments of the present disclosure provide a non-transitory computer-readable medium storing a program for managing a virtual power plant on a user interface. The program, when executed by a computer, configures the computer to display, in a first portion of the user interface, a calendar grid of cells, the calendar grid having a group of columns each corresponding to a group of available dates and a group of rows each corresponding to a group of time slots. The program, when executed by a computer, further configures the computer to receive a first user input in a second portion of the user interface to create a power generation offer from a particular distributed energy resource at a particular time slot and a particular date. The program, when executed by a computer, further configures the computer to, in response to receiving the first user input, display the power generation offer on the calendar grid within a particular cell corresponding to the particular time slot and the particular date. The program, when executed by a computer, further configures the computer to, in response to receiving the first user input, submit the power generation offer to a distributed energy resource market.

Some embodiments of the present disclosure provide a system for managing a virtual power plant on a user interface. The system comprises a processor and a non-transitory computer-readable medium storing a set of instructions, which when executed by the processor, configure the processor to display, in a first portion of the user interface, a calendar grid of cells, the calendar grid having a group of columns each corresponding to a group of available dates and a group of rows each corresponding to a group of time slots. The instructions, when executed by the processor, further configure the processor to receive a first user input in a second portion of the user interface to create a power generation offer from a particular distributed energy resource at a particular time slot and a particular date. The instructions, when executed by the processor, further configure the processor to, in response to receiving the first user input, display the power generation offer on the calendar grid within a particular cell corresponding to the particular time slot and the particular date. The instructions, when executed by the processor, further configure the processor to, in response to receiving the first user input, submit the power generation offer to a distributed energy resource market.

Some embodiments of the present disclosure provide a method for receiving an operational schedule of a user associated with a distributed energy resource, determining a time frame for a resource type associated with the distributed energy resource of the operational schedule, and generating an alert regarding the resource type associated with the distributed energy resource of the operational schedule.

Some embodiments of the present disclosure provide a non-transitory computer-readable medium storing instructions that, when executed by a processor, cause the processor to perform a method that includes receiving an operational schedule of a user associated with a distributed energy resource, determining a time frame for a resource type associated with the distributed energy resource of the operational schedule; and generating an alert regarding the resource type associated with the distributed energy resource of the operational schedule.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments.

FIG. 1 illustrates a network architecture used to implement distributed energy resource market scheduling, according to some embodiments.

FIG. 2 is a block diagram illustrating details of a system for distributed energy resource market scheduling, according to some embodiments.

FIG. 3 illustrates an exemplary scheduling user interface for a virtual power plant, according to certain aspects of the disclosure.

FIG. 4 illustrates an exemplary scheduling user interface for a single distributed energy resource of the virtual power plant, according to certain aspects of the disclosure.

FIG. 5 illustrates an exemplary aggregate power user interface for a virtual power plant, according to certain aspects of the disclosure.

FIG. 6 illustrates an exemplary graphical user interface for creating a schedule for a single distributed energy resource, according to certain aspects of the disclosure.

FIG. 7 illustrates an exemplary graphical user interface for determining the total forecasted value from a virtual power plant, according to certain aspects of the disclosure.

FIG. 8 illustrates an exemplary graphical user interface for a virtual power plant dashboard, according to certain aspects of the disclosure.

FIG. 9 illustrates an exemplary graphical user interface for monitoring operating reserves of a virtual power plant, according to certain aspects of the disclosure.

FIG. 10 is a flowchart illustrating a process for managing a virtual power plant on a user interface, according to some embodiments.

FIG. 11 is a block diagram illustrating an exemplary computer system with which aspects of the subject technology can be implemented, according to some embodiments.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

All references cited anywhere in this specification, including the Background and Detailed Description sections, are incorporated by reference as if each had been individually incorporated.

The term “virtual power plant,” as used herein, refers to a networked aggregation of distributed energy resources (DERs) that operates as a single, coordinated system to provide electricity generation, energy storage, and demand response capabilities. Through software and communication technologies, a VPP can monitor, forecast, optimize, and control these diverse assets in real time, enabling them to collectively function as a unified power plant. This aggregation allows for more efficient management of energy supply and demand, enhanced grid stability, and increased integration of renewable energy sources into the existing power infrastructure.

The types of resources that comprise DERs may include, but are not limited to, renewable energy sources such as solar power, wind power, hydroelectric power, and geothermal power; energy storage systems such as commercial and/or residential battery storage systems and electric vehicles; and flexible demand resources such as smart appliances and industrial/commercial loads. DERs may also include non-renewable energy sources like coal and natural gas, backup power sources like generators, biomass plants, and any other power source that provides power.

According to some embodiments, an automated distributed energy resource market scheduler is configured to collect and aggregate a plurality of individual distributed energy resources into a single distributed energy resource market schedule for submission to one or more distributed energy resource markets. The automated distributed energy resource market scheduler provides a user interface to permit users of each individual distributed energy resource to create and modify an individual schedule for the user's individual distributed energy resource for one or more days.

According to some embodiments, the automated distributed energy resource market scheduler enables users of each individual distributed energy resource to create and modify an individual schedule for the user's individual distributed energy resource for one or more days to interact with the automated distributed energy resource market scheduler using application programming interface (API) commands.

According to some embodiments, the automated distributed energy resource market scheduler includes market-specific configurable parameters supported by one or more distributed energy resource markets. The automated distributed energy resource market scheduler automatically compiles and submits market offers in supported formats for one or more distributed energy resource markets utilizing the configurable parameters.

According to some embodiments, the automated distributed energy resource market scheduler supports program-specific time windows for the distributed energy resource schedules, includes offer “bot”-based confirmation of submission of market offers, and provides error handling and alerting for submission of market offers.

According to some embodiments, the automated distributed energy resource market scheduler also provides email-based push notifications of customer schedules to confirm in-market hours and provides configurable daily/weekly/never in a scheduling interface.

Some embodiments of the present disclosure provide a method for receiving an operational schedule of a user associated with a distributed energy resource, determining a time frame for a resource type associated with the distributed energy resource of the operational schedule, and generating an alert regarding the resource type associated with the distributed energy resource of the operational schedule.

According to some aspects, the receiving of an operational schedule of a user associated with a distributed energy resource is through a user interface.

According to some aspects, the operational schedule of a user is associated with a distributed energy resource comprising a plurality of resource types.

According to some aspects, the operational schedule of a user is associated with a distributed energy resource further comprising error handling and alerting.

According to some aspects, the operational schedule of a user is associated with a distributed energy resource further comprising a configurable scheduling interface.

According to some aspects, the operational schedule of a user is associated with a distributed energy resource further comprising generating temporal constraints and availabilities based on the operational schedule.

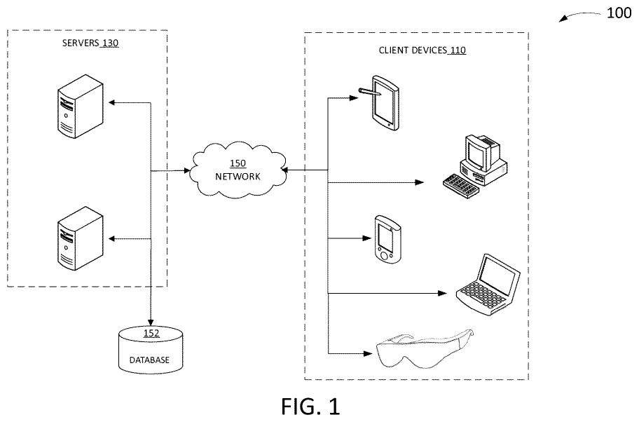

FIG. 1 illustrates a network architecture 100 used to implement distributed energy resource market scheduling, according to some embodiments. The network architecture 100 may include one or more client devices 110 and servers 130, communicatively coupled via a network 150 with each other and to at least one database, e.g., database 152. Database 152 may store data and files associated with the servers 130 and/or the client devices 110. In some embodiments, client devices 110 collect data, video, images, and the like, for upload to the servers 130 to store in the database 152.

The network 150 may include a wired network (e.g., fiber optics, copper wire, telephone lines, and the like) and/or a wireless network (e.g., a satellite network, a cellular network, a radiofrequency (RF) network, Wi-Fi, Bluetooth, and the like). The network 150 may further include one or more of a local area network (LAN), a wide area network (WAN), the Internet, and the like. Further, the network 150 may include, but is not limited to, any one or more of the following network topologies, including a bus network, a star network, a ring network, a mesh network, and the like.

Client devices 110 may include, but are not limited to, laptop computers, desktop computers, and mobile devices such as smart phones, tablets, televisions, wearable devices, head-mounted devices, display devices, and the like.

In some embodiments, the servers 130 may be a cloud server or a group of cloud servers. In other embodiments, some or all of the servers 130 may not be cloud-based servers (i.e., may be implemented outside of a cloud computing environment, including but not limited to an on-premises environment), or may be partially cloud-based. Some or all of the servers 130 may be part of a cloud computing server, including but not limited to rack-mounted computing devices and panels. Such panels may include but are not limited to processing boards, switchboards, routers, and other network devices. In some embodiments, the servers 130 may include the client devices 110 as well, such that they are peers.

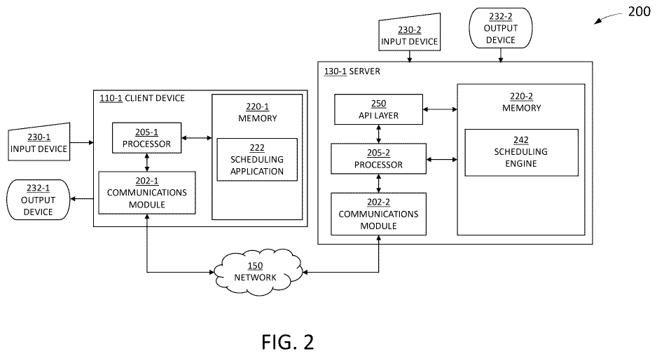

FIG. 2 is a block diagram illustrating details of a system 200 for distributed energy resource market scheduling, according to some embodiments. Specifically, the example of FIG. 2 illustrates an exemplary client device 110-1 (of the client devices 110) and an exemplary server 130-1 (of the servers 130) in the network architecture 100 of FIG. 1.

Client device 110-1 and server 130-1 are communicatively coupled over network 150 via respective communications modules 202-1 and 202-2 (hereinafter, collectively referred to as “communications modules 202”). Communications modules 202 are configured to interface with network 150 to send and receive information, such as requests, data, messages, commands, and the like, to other devices on the network 150.

Communications modules 202 can be, for example, modems or Ethernet cards, and/or may include radio hardware and software for wireless communications (e.g., via electromagnetic radiation, such as radiofrequency (RF), near field communications (NFC), Wi-Fi, and Bluetooth radio technology).

The client device 110-1 and server 130-1 also include processors 205-1 and 205-2 and memories 220-1 and 220-2, respectively. Processors 205-1 and 205-2 and memories 220-1 and 220-2 will be collectively referred to, hereinafter, as “processors 205” and “memories 220.” Processors 205 may be configured to execute instructions stored in memories 220, to cause client device 110-1 and/or server 130-1 to perform methods and operations consistent with embodiments of the present disclosure.

The client device 110-1 and the server 130-1 are each coupled to at least one input device 230-1 and input device 230-2, respectively (hereinafter, collectively referred to as “input devices 230”). The input devices 230 can include a mouse, a controller, a keyboard, a pointer, a stylus, a touchscreen, a microphone, voice recognition software, a joystick, a virtual joystick, a touch-screen display, and the like. In some embodiments, the input devices 230 may include cameras, microphones, sensors, and the like. In some embodiments, the sensors may include touch sensors, acoustic sensors, inertial motion units and the like.

The client device 110-1 and the server 130-1 are also coupled to at least one output device 232-1 and output device 232-2, respectively (hereinafter, collectively referred to as “output devices 232”). The output devices 232 may include a screen, a display (e.g., a same touchscreen display used as an input device), a speaker, an alarm, and the like. A user may interact with client device 110-1 and/or server 130-1 via the input devices 230 and the output devices 232.

Memory 220-1 may further include a scheduling application 222, configured to execute on client device 110-1 and couple with input device 230-1 and output device 232-1. The scheduling application 222 may be downloaded by the user from server 130-1, and/or may be hosted by server 130-1. The scheduling application 222 may include specific instructions which, when executed by processor 205-1, cause operations to be performed consistent with embodiments of the present disclosure. In some embodiments, the scheduling application 222 runs on an operating system (OS) installed in client device 110-1. In some embodiments, scheduling application 222 may run within a web browser. In some embodiments, the processor 205-1 is configured to control a graphical user interface (GUI) (e.g., spanning at least a portion of input devices 230 and output devices 232) for the user of client device 110-1 to access the server 130-1.

In some embodiments, memory 220-2 includes a scheduling engine 242. The scheduling engine 242 may be configured to perform methods and operations consistent with embodiments of the present disclosure. The scheduling engine 242 may share or provide features and resources with the client device 110-1, including data, libraries, and/or applications retrieved with scheduling engine 242 (e.g., scheduling application 222). The user may access the scheduling engine 242 through the scheduling application 222. The scheduling application 222 may be installed in client device 110-1 by the scheduling engine 242 and/or may execute scripts, routines, programs, applications, and the like provided by the scheduling engine 242. The scheduling application 222 may communicate with scheduling engine 242 through API layer 250, for example.

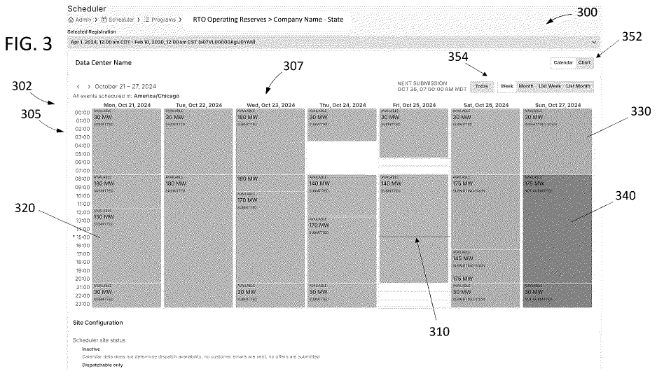

FIG. 3 illustrates an exemplary scheduling user interface 300 for a virtual power plant, according to certain aspects of the disclosure. The interface 300 includes a calendar grid 302, with rows 305 representing multiple time slots (in this example, hours of each day) throughout the day and columns 307 representing different dates (in this example, days of the week). An indicator 310 shows the current time and date, and the current date may also be highlighted (in this example, in yellow, corresponding to the current date of Friday, Oct. 25, 2024). The calendar grid has various entries, each representing a power generation offer, that span one or more time slots on a given date.

For example, entry 320 was submitted and confirmed for 150 megawatts (MW) on Monday, Oct. 21, 2024 (i.e., in the past relative to the current date), between 12:00 to 21:00. As another example, entry 330 was submitted and is pending for 30 MW on Sunday, Oct. 27, 2024 (i.e., in the future relative to the current date), between 00:00 to 08:00. As yet another example, entry 340 has not yet been submitted, for 175 MW on Sunday, Oct. 27, 2024 (i.e., in the future relative to the current date), between 09:00 to 21:00. In this example, the amount of power (in MW) and the submission status (confirmed submitted, pending, not yet submitted) of the power generation offers are displayed in the corresponding cell.

In this example, the user interface may also be represented as a chart instead of a calendar grid, for example by a user input at interface element 352. The calendar grid view may also be modified by a user input at interface element 354 to show the current day, week, month, year, and other ranges of dates as desired.

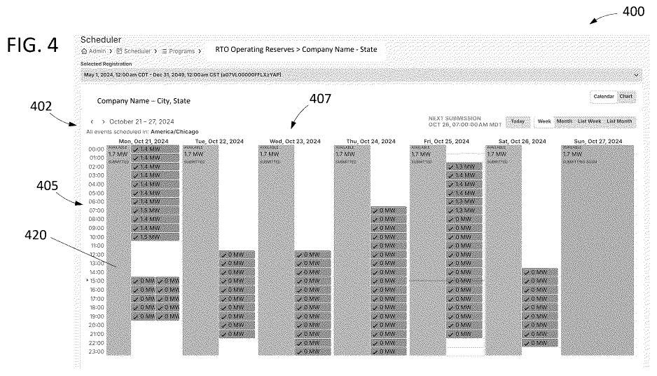

FIG. 4 illustrates an exemplary scheduling user interface 400 for a single distributed energy resource of the virtual power plant, according to certain aspects of the disclosure. The interface 400 is similar to the embodiment of the interface 300 discussed above with respect to FIG. 3, and like reference numerals have been used to refer to the same or similar components. A detailed description of these components will be omitted, and the following discussion focuses on the differences between these embodiments. Any of the various features discussed with any one of the embodiments discussed herein may also apply to and be used with any other embodiments.

In the calendar grid 402, the average power generation is shown for each power generation offer, each of which spans one or more time slots (hours, in this example). The actual power generation for each individual time slot is also shown in this example, representing either a measured amount of power generation during that time slot, or a forecasted capacity due to constraints, policies, or other factors. As an example, entry 420 is submitted with an average of 1.7 MW, but from 00:00 to 10:00 the actual generation was 1.4 MW or 1.5 MW on an hourly basis and was zero MW during a block of time from 15:00 to 20:00.

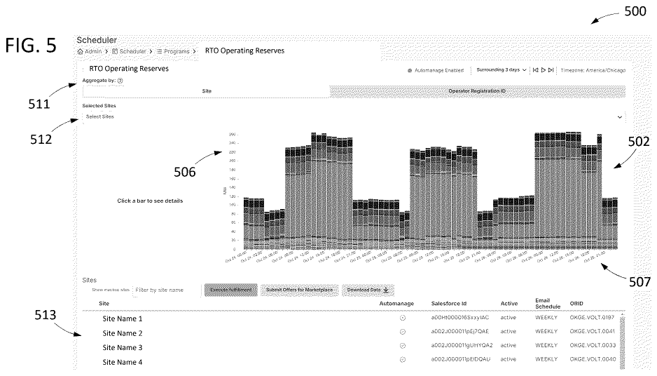

FIG. 5 illustrates an exemplary aggregate power user interface 500 for a virtual power plant, according to certain aspects of the disclosure. The user interface 500 is similar to the embodiments of the user interface 300 and user interface 400 discussed above with respect to FIG. 3 and FIG. 4, respectively, and like reference numerals have been used to refer to the same or similar components. A detailed description of these components will be omitted, and the following discussion focuses on the differences between these embodiments. Any of the various features discussed with any one of the embodiments discussed herein may also apply to and be used with any other embodiments.

The interface 500 includes a chart 502 of aggregate power generation (on a vertical axis 506) versus time (on a horizontal axis 507) for a distributed power marketplace. In this example, the power generation is shown in MW and the time is shown in 3-hour increments, and these units or axes' scales may be configured by user input. The aggregation may be performed over different power generation sites, distributed energy resources, virtual power plants, or other entity or entities, as selected by a user input on control 511. The entities may be selected by a user input on control 512 and the data sources to be aggregated may be refined by a user input on selection sub-interface 513.

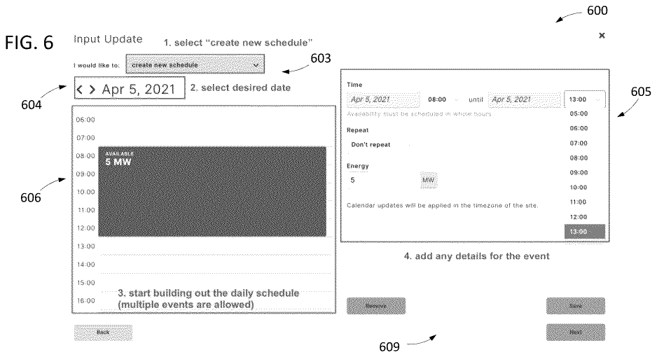

FIG. 6 illustrates an exemplary graphical user interface 600 for creating a schedule for a single distributed energy resource, according to certain aspects of the disclosure. The user interface 600 is similar to the embodiments of the user interfaces 300-500 discussed above with respect to FIGS. 3-5, respectively, and like reference numerals have been used to refer to the same or similar components. A detailed description of these components will be omitted, and the following discussion focuses on the differences between these embodiments. Any of the various features discussed with any one of the embodiments discussed herein may also apply to and be used with any other embodiments.

The interface 600 includes a control 603 to select adding a new entry or modifying an existing entry. In this example, “create new schedule” has been selected. The interface 600 also includes control 604 to select a date for the entry, and control 605 to select one or more time slots (hours, in this example) as well as the amount of power and any repeating criteria. A preview of the schedule is shown in interface region 606. Once the entry has been configured, the entry may be saved or discarded with a user input in interface region 609.

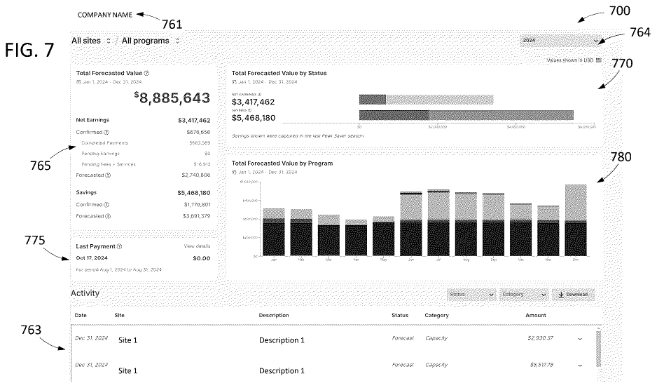

FIG. 7 illustrates an exemplary graphical user interface 700 for determining the total forecasted value from a virtual power plant, according to certain aspects of the disclosure. Any of the various features discussed with any one of the embodiments discussed herein may also apply to and be used with any other embodiments.

The interface 700 includes a control 761 for a user to select a distributed energy resource of the virtual power plant. One or more resources/sites of the selected distributed energy resource may be selected by a user input on selection sub-interface 763. For the selected distributed energy resource and/or sites, a total forecasted value (in this example, shown in USD currency values, though other currencies may be selected) for a given year (e.g., selected by a user input on control 764) may be shown in user interface region 765, and broken down by status (net earnings vs. savings) in user interface region 770. The last payment to the distributed energy resource may be shown in user interface region 775, and a breakdown of forecasted value by month in user interface region 780.

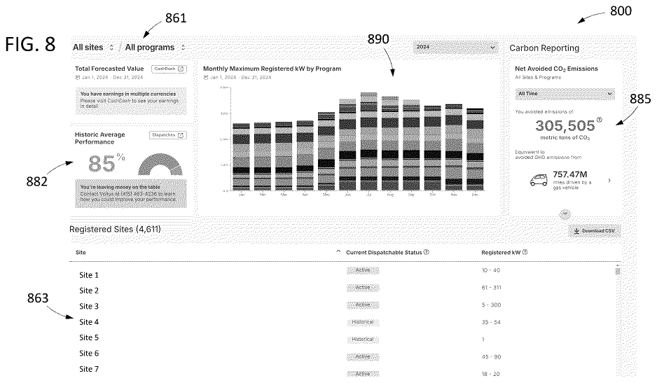

FIG. 8 illustrates an exemplary graphical user interface 800 for a virtual power plant dashboard, according to certain aspects of the disclosure. Any of the various features discussed with any one of the embodiments discussed herein may also apply to and be used with any other embodiments.

The interface 800 includes a control 861 for a user to select one or more distributed energy resources and/or individual resources/sites of the virtual power plant. The selection of resources/sites may be further refined by a user input on selection sub-interface 863. For the selected distributed energy resource and/or sites, the historic average performance may be shown in a user interface region 882, as a percentage in this example. In addition, the net avoided emissions (here expressed in units of metric tons of CO₂) may also be shown in a user interface region 885, and monthly maximum registered energy generation (here expressed in units of kilowatts) in a user interface region 890. The net avoided emissions may also be shown in alternative unit equivalents, including but not limited to miles driven by a gas vehicle.

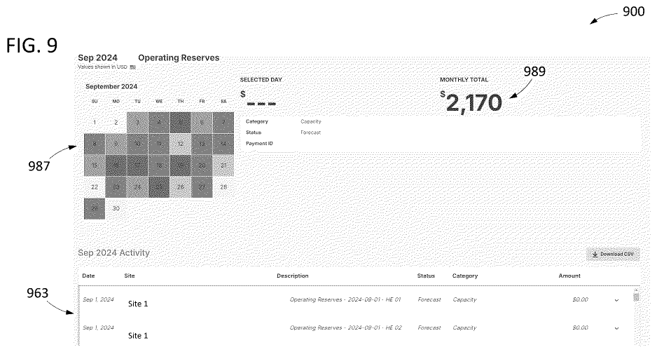

FIG. 9 illustrates an exemplary graphical user interface 900 for monitoring operating reserves of a virtual power plant, according to certain aspects of the disclosure. Any of the various features discussed with any one of the embodiments discussed herein may also apply to and be used with any other embodiments.

The selection of resources/sites may be further refined by a user input on selection sub-interface 963. A calendar grid 987 may be shown for a selected month, and corresponding monthly total value is displayed in user interface region 989.

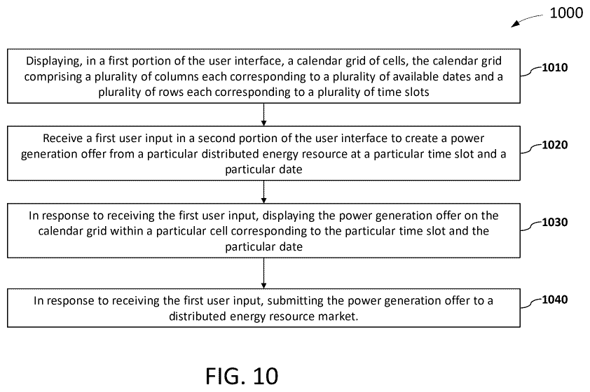

FIG. 10 is a flowchart illustrating a process 1000 for managing a virtual power plant on a user interface performed by a client device (e.g., client device 110-1, etc.) and/or a client server (e.g., server 130-1, etc.), according to some embodiments. In some embodiments, one or more operations in process 1000 may be performed by a processor circuit (e.g., processors 205, etc.) executing instructions stored in a memory circuit (e.g., memories 220, etc.) of a system (e.g., system 200, etc.) as disclosed herein. For example, operations in process 1000 may be performed by scheduling application 222, scheduling engine 242, or some combination thereof. Moreover, in some embodiments, a process consistent with this disclosure may include at least operations in process 1000 performed in a different order, simultaneously, quasi-simultaneously, or overlapping in time.

At 1010, the process 1000 displays, in the user interface, a calendar grid of cells, the calendar grid having multiple columns each corresponding to multiple available dates and multiple rows each corresponding to multiple time slots.

The calendar grid may display multiple power generation offers in multiple cells corresponding to different time slots and dates. In some embodiments, the calendar grid may be configured (e.g., by user inputs) to show different views of power generation offers corresponding to one or more distributed energy sources, or aggregate power generation offers for a virtual power plant including one or more distributed energy sources, a distributed energy resource market, and/or a regional transmission organization.

In some embodiments, the calendar grid may be configured (e.g., by user inputs) to display an indicator with each available power generation offer to indicate a status of the available power generation offer. The status may include: (1) confirmed submission to the distributed energy resource market, (2) pending confirmation of submission to the distributed energy resource market, and (3) no submission to the distributed energy resource market. The calendar grid may also be configured (e.g., by user inputs) to display an average power generation amount for a power generation offer in the respective cell.

In some embodiments, the calendar grid may be configured (e.g., by user inputs) to display in the user interface one or more of a forecasted currency value of the power generation offer (e.g., in USD), and/or an equivalent emissions total of the power generation offer (e.g., in metric tons of CO₂ equivalent, miles driven by a gasoline vehicle, and the like).

At 1020, the process 1000 receives a user input in the user interface to create or modify a power generation offer from a particular distributed energy resource at a particular time slot and a particular date. The particular distributed energy resource may include one or more resource types, including but not limited to renewable energy sources, energy storage systems, flexible demand resources, backup power sources, and non-renewable energy sources. The user input may include a selection of the particular date and/or the particular time slot.

In some embodiments, the virtual power plant includes multiple distributed energy resources, and the process 1000 receives another user input in the user interface to select the particular distributed energy resource.

In some embodiments, the particular distributed energy resource includes multiple energy resources, and the process 1000 receives another user input in the user interface to select one or more of the energy resources.

At 1030, in response to receiving the first user input, the process 1000 displays the power generation offer on the calendar grid within a particular cell corresponding to the particular time slot and the particular date.

At 1040, in response to receiving the first user input, the process 1000 submits the power generation offer to a distributed energy resource market. In some embodiments, the process 1000 generates an aggregate power generation offer from multiple power generation offers and submits the aggregate power generation offer to the distributed energy resource market.

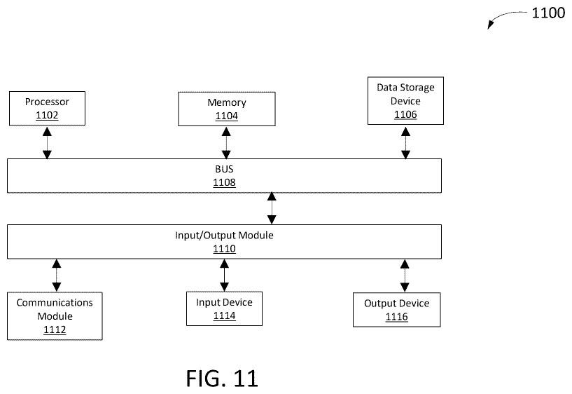

FIG. 11 is a block diagram illustrating an exemplary computer system 1100 with which aspects of the subject technology can be implemented. In certain aspects, the computer system 1100 may be implemented using hardware or a combination of software and hardware, either in a dedicated server, integrated into another entity, or distributed across multiple entities. As a non-limiting example, the computer system 1100 may be one or more of the servers 130 and/or the client devices 110.

Computer system 1100 includes a bus 1108 or other communication mechanism for communicating information, and a processor 1102 coupled with bus 1108 for processing information. By way of example, the computer system 1100 may be implemented with one or more processors 1102. Processor 1102 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 1100 can include, in addition to hardware, code that creates an execution environment for the computer program in question, e.g., code that constitutes processor firmware, a protocol stack, a database management system, an operating system, or a combination of one or more of them stored in an included memory 1104, such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled to bus 1108 for storing information and instructions to be executed by processor 1102. The processor 1102 and the memory 1104 can be supplemented by, or incorporated in, special purpose logic circuitry.

The instructions may be stored in the memory 1104 and implemented in one or more computer program products, i.e., one or more modules of computer program instructions encoded on a computer-readable medium for execution by, or to control the operation of, the computer system 1100, and according to any method well-known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, Wirth languages, and xml-based languages. Memory 1104 may also be used for storing temporary variable or other intermediate information during execution of instructions to be executed by processor 1102.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 1100 further includes a data storage device 1106 such as a magnetic disk or optical disk, coupled to bus 1108 for storing information and instructions. Computer system 1100 may be coupled via input/output module 1110 to various devices. The input/output module 1110 can be any input/output module. Exemplary input/output modules 1110 include data ports such as USB ports. The input/output module 1110 is configured to connect to a communications module 1112. Exemplary communications modules 1112 include networking interface cards, such as Ethernet cards and modems. In certain aspects, the input/output module 1110 is configured to connect to a plurality of devices, such as an input device 1114 and/or an output device 1116. Exemplary input devices 1114 include a keyboard and a pointing device, e.g., a mouse or a trackball, by which a user can provide input to the computer system 1100. Other kinds of input devices 1114 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback, and input from the user can be received in any form, including acoustic, speech, tactile, or brain wave input. Exemplary output devices 1116 include display devices such as an LCD (liquid crystal display) monitor, for displaying information to the user.

According to one aspect of the present disclosure, the above-described embodiments can be implemented using a computer system 1100 in response to processor 1102 executing one or more sequences of one or more instructions contained in memory 1104. Such instructions may be read into memory 1104 from another machine-readable medium, such as data storage device 1106. Execution of the sequences of instructions contained in the main memory 1104 causes processor 1102 to perform the process steps described herein. One or more processors in a multi-processing arrangement may also be employed to execute the sequences of instructions contained in memory 1104. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., such as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 1100 can include clients and servers. A client and server are generally remote from each other and typically interact through a communication network. The relationship of client and server arises by virtue of computer programs running on the respective computers and having a client-server relationship to each other. Computer system 1100 can be, for example, and without limitation, a desktop computer, laptop computer, or tablet computer. Computer system 1100 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 1102 for execution. Such a medium may take many forms, including, but not limited to, non-volatile media, volatile media, and transmission media. Non-volatile media include, for example, optical or magnetic disks, such as data storage device 1106. Volatile media include dynamic memory, such as memory 1104. Transmission media include coaxial cables, copper wire, and fiber optics, including the wires that comprise bus 1108. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As the user computing system 1100 reads application data and provides an application, information may be read from the application data and stored in a memory device, such as the memory 1104. Additionally, data from the memory 1104 servers accessed via a network, the bus 1108, or the data storage 1106 may be read and loaded into the memory 1104. Although data is described as being found in the memory 1104, it will be understood that data does not have to be stored in the memory 1104 and may be stored in other memory accessible to the processor 1102 or distributed among several media, such as the data storage 1106.

Many of the above-described features and applications may be implemented as software processes that are specified as a set of instructions recorded on a computer-readable storage medium (alternatively referred to as computer-readable media, machine-readable media, or machine-readable storage media). When these instructions are executed by one or more processing unit(s) (e.g., one or more processors, cores of processors, or other processing units), they cause the processing unit(s) to perform the actions indicated in the instructions. Examples of computer-readable media include, but are not limited to, RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, ultra-density optical discs, any other optical or magnetic media, and floppy disks. In one or more embodiments, the computer-readable media does not include carrier waves and electronic signals passing wirelessly or over wired connections, or any other ephemeral signals. For example, the computer-readable media may be entirely restricted to tangible, physical objects that store information in a form that is readable by a computer. In some embodiments, the computer-readable media is non-transitory computer-readable media, or non-transitory computer-readable storage media.

In one or more embodiments, a computer program product (also known as a program, software, software application, script, or code) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

While the above discussion primarily refers to microprocessor or multi-core processors that execute software, one or more embodiments are performed by one or more integrated circuits, such as application specific integrated circuits (ASICs) or field programmable gate arrays (FPGAs). In one or more embodiments, such integrated circuits execute instructions that are stored on the circuit itself.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way), all without departing from the scope of the subject technology.

It is understood that any specific order or hierarchy of blocks in the processes disclosed is an illustration of example approaches. Based upon implementation preferences, it is understood that the specific order or hierarchy of blocks in the processes may be rearranged, or that not all illustrated blocks be performed. Any of the blocks may be performed simultaneously. In one or more embodiments, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The subject technology is illustrated, for example, according to various aspects described above. The present disclosure is provided to enable any person skilled in the art to practice the various aspects described herein. The disclosure provides various examples of the subject technology, and the subject technology is not limited to these examples. Various modifications to these aspects will be readily apparent to those skilled in the art, and the generic principles defined herein may be applied to other aspects.

A reference to an element in the singular is not intended to mean “one and only one” unless specifically stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the disclosure.

To the extent that the terms “include,” “have,” or the like is used in the description or the claims, such term is intended to be inclusive in a manner similar to the term “comprise” as “comprise” is interpreted when employed as a transitional word in a claim.

The word “exemplary” is used herein to mean “serving as an example, instance, or illustration.” Any embodiment described herein as “exemplary” is not necessarily to be construed as preferred or advantageous over other embodiments. In one aspect, various alternative configurations and operations described herein may be considered to be at least equivalent.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such as an embodiment may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such as a configuration may refer to one or more configurations and vice versa.

In one aspect, unless otherwise stated, all measurements, values, ratings, positions, magnitudes, sizes, and other specifications that are set forth in this specification, including in the claims that follow, are approximate, not exact. In one aspect, they are intended to have a reasonable range that is consistent with the functions to which they relate and with what is customary in the art to which they pertain. It is understood that some or all steps, operations, or processes may be performed automatically, without the intervention of a user.

Method claims may be provided to present elements of the various steps, operations, or processes in a sample order, and are not meant to be limited to the specific order or hierarchy presented.

In one aspect, a method may be an operation, an instruction, or a function and vice versa. In one aspect, a claim may be amended to include some or all of the words (e.g., instructions, operations, functions, or components) recited in other one or more claims, one or more words, one or more sentences, one or more phrases, one or more paragraphs, and/or one or more claims.

All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No claim element is to be construed under the provisions of 35 U.S.C. § 112, sixth paragraph, unless the element is expressly recited using the phrase “means for” or, in the case of a method claim, the element is recited using the phrase “step for.”

The Title, Background, and Brief Description of the Drawings of the disclosure are hereby incorporated into the disclosure and are provided as illustrative examples of the disclosure, not as restrictive descriptions. It is submitted with the understanding that they will not be used to limit the scope or meaning of the claims. In addition, in the Detailed Description, it can be seen that the description provides illustrative examples, and the various features are grouped together in various embodiments for the purpose of streamlining the disclosure. This method of disclosure is not to be interpreted as reflecting an intention that the included subject matter requires more features than are expressly recited in any claim. Rather, as the claims reflect, inventive subject matter lies in less than all features of a single disclosed configuration or operation. The claims are hereby incorporated into the Detailed Description, with each claim standing on its own to represent separately patentable subject matter.

The claims are not intended to be limited to the aspects described herein but are to be accorded the full scope consistent with the language of the claims and to encompass all legal equivalents. Notwithstanding, none of the claims are intended to embrace subject matter that fails to satisfy the requirement of 35 U.S.C. § 101, 102, or 103, nor should they be interpreted in such a way.

Embodiments consistent with the present disclosure may be combined with any combination of features or aspects of embodiments described herein.

1. A method of managing a virtual power plant on a user interface, comprising:
displaying, in a first portion of the user interface, a calendar grid of cells, the calendar grid comprising a plurality of columns each corresponding to a plurality of available dates and a plurality of rows each corresponding to a plurality of time slots;
receiving a first user input in a second portion of the user interface to create a power generation offer from a particular distributed energy resource at a particular time slot and a particular date;
in response to receiving the first user input, displaying the power generation offer on the calendar grid within a particular cell corresponding to the particular time slot and the particular date; and
in response to receiving the first user input, submitting the power generation offer to a distributed energy resource market.

2. The method of claim 1, wherein the virtual power plant comprises a plurality of distributed energy resources, the method further comprising:
receiving a second user input in a third portion of the user interface to select the particular distributed energy resource from the plurality of distributed energy resources.

3. The method of claim 1, wherein each distributed energy resource comprises one or more resource types.

4. The method of claim 1, further comprising:
displaying a plurality of power generation offers on the calendar grid in a plurality of cells corresponding to respective time slots and dates of the plurality of respective power generation offers; and
displaying an indicator with each available power generation offer to indicate a status of the available power generation offer, wherein the status is one of confirmed submission to the distributed energy resource market, pending confirmation of submission to the distributed energy resource market, or not submitted to the distributed energy resource market.

5. The method of claim 4, further comprising displaying an available power generation amount from the particular distributed energy resource in the particular cell.

6. The method of claim 4, further comprising displaying an average power generation amount for the power generation offer in the particular cell.

7. The method of claim 1, further comprising displaying in a third portion of the user interface one or more of a forecasted currency value of the power generation offer, and an equivalent emissions total of the power generation offer.

8. The method of claim 1, wherein the first user input comprises a selection of the particular date from the plurality of available dates and further comprises a selection of the particular time slot from the plurality of time slots.

9. The method of claim 1, further comprising:
receiving a second user input in the second portion of the user interface to modify the power generation offer, resulting in a modified power generation offer having one or more of a modified date or a modified time slot;
in response to receiving the second user input, displaying the modified power generation offer on the calendar grid within a different cell corresponding to the one or more modified date or modified time slot; and
in response to receiving the second user input, submitting the modified power generation offer to a distributed energy resource market.

10. The method of claim 1, further comprising:
receiving a plurality of power generation offers from a plurality of distributed energy resources;
displaying the plurality of power generation offers on the calendar grid within a plurality of cells corresponding to respective time slots and dates of the power generation offers;
generating an aggregate power generation offer from the plurality of power generation offers; and
submitting the aggregate power generation offer to the distributed energy resource market.

11. A non-transitory computer-readable medium storing a program for managing a virtual power plant on a user interface, which when executed by a computer, configures the computer to:
display, in a first portion of the user interface, a calendar grid of cells, the calendar grid comprising a plurality of columns each corresponding to a plurality of available dates and a plurality of rows each corresponding to a plurality of time slots;
receive a first user input in a second portion of the user interface to create a power generation offer from a particular distributed energy resource at a particular time slot and a particular date;
in response to receiving the first user input, display the power generation offer on the calendar grid within a particular cell corresponding to the particular time slot and the particular date; and
in response to receiving the first user input, submit the power generation offer to a distributed energy resource market.

12. The non-transitory computer-readable medium of claim 11, wherein the program, when executed by the computer, further configures the computer to:
display a plurality of power generation offers on the calendar grid in a plurality of cells corresponding to respective time slots and dates of the plurality of respective power generation offers; and
display an indicator with each available power generation offer to indicate a status of the available power generation offer, wherein the status is one of confirmed submission to the distributed energy resource market, pending confirmation of submission to the distributed energy resource market, or not submitted to the distributed energy resource market.

13. The non-transitory computer-readable medium of claim 12, wherein the program, when executed by the computer, further configures the computer to display an available power generation amount from the particular distributed energy resource in the particular cell.

14. The non-transitory computer-readable medium of claim 12, wherein the program, when executed by the computer, further configures the computer to display an average power generation amount for the power generation offer in the particular cell.

15. The non-transitory computer-readable medium of claim 11, wherein the program, when executed by the computer, further configures the computer to display in a third portion of the user interface one or more of a forecasted currency value of the power generation offer, and an equivalent emissions total of the power generation offer.

16. The non-transitory computer-readable medium of claim 11, wherein the program, when executed by the computer, further configures the computer to:
receive a second user input in the second portion of the user interface to modify the power generation offer, resulting in a modified power generation offer having one or more of a modified date or a modified time slot;
in response to receiving the second user input, display the modified power generation offer on the calendar grid within a different cell corresponding to the one or more modified date or modified time slot; and
in response to receiving the second user input, submit the modified power generation offer to a distributed energy resource market.

17. The non-transitory computer-readable medium of claim 10, wherein the program, when executed by the computer, further configures the computer to:
receive a plurality of power generation offers from a plurality of distributed energy resources;
display the plurality of power generation offers on the calendar grid within a plurality of cells corresponding to respective time slots and dates of the power generation offers;
generate an aggregate power generation offer from the plurality of power generation offers; and
submit the aggregate power generation offer to the distributed energy resource market.

18. A system for managing a virtual power plant on a user interface, comprising:
a processor; and
a non-transitory computer-readable medium storing a set of instructions, which when executed by the processor, configure the system to:
display, in a first portion of the user interface, a calendar grid of cells, the calendar grid comprising a plurality of columns each corresponding to a plurality of available dates and a plurality of rows each corresponding to a plurality of time slots;
receive a first user input in a second portion of the user interface to create a power generation offer from a particular distributed energy resource at a particular time slot and a particular date;
in response to receiving the first user input, display the power generation offer on the calendar grid within a particular cell corresponding to the particular time slot and the particular date; and
in response to receiving the first user input, submit the power generation offer to a distributed energy resource market.

19. The system of claim 18, wherein the instructions, when executed by the computer, further configure the computer to:
receive a second user input in the second portion of the user interface to modify the power generation offer, resulting in a modified power generation offer having one or more of a modified date or a modified time slot;
in response to receiving the second user input, display the modified power generation offer on the calendar grid within a different cell corresponding to the one or more modified date or modified time slot; and
in response to receiving the second user input, submit the modified power generation offer to a distributed energy resource market.

20. The system of claim 18, wherein the instructions, when executed by the computer, further configure the computer to:
receive a plurality of power generation offers from a plurality of distributed energy resources;
display the plurality of power generation offers on the calendar grid within a plurality of cells corresponding to respective time slots and dates of the power generation offers;
generate an aggregate power generation offer from the plurality of power generation offers; and
submit the aggregate power generation offer to the distributed energy resource market.
